(19) United States
(12) Patent Application Publication
(10) Pub. No.: US 2026/0004195 A1
(43) Pub. Date: Jan. 1, 2026

(54) A PARAMETER SERVER ORCHESTRATION PROCEDURE FOR ACCELERATING THE TRAINING OF LARGE LANGUAGE MODELS

(71) Applicant: NEC Laboratories America, Inc., Princeton, NJ (US)

(72) Inventors: Philip JI, Cranbury, NJ (US); Ting WANG, West Windsor, NJ (US); Zilong YE, La Verne, CA (US)

(73) Assignee: NEC Laboratories America, Inc., Princeton, NJ (US)

(21) Appl. No.: 19/256,187

(22) Filed: Jul. 1, 2025

Related U.S. Application Data
(60) Provisional application No. 63/666,278, filed on Jul. 1, 2024.

(51) Int. Cl. G06N 20/00

(52) U.S. Cl. CPC G06N 20/00

(57) ABSTRACT

Disclosed is a parameter server orchestration architecture and procedure for accelerating the training of large language models that advantageously improves inter-machine network traffic thereby accelerating the training speed of LLMs. Our inventive procedure advantageously (i) minimizes the amount of inter-machine network traffic thereby accelerating the training speed of LLMs from a global perspective; (ii) optimizes the topology design for a given LLM training job so that less inter-machine traffic is produced; (iii) optimizes the number of workers used and their placement for a given LLM training job; (iv) optimizes number of parameter servers employed and their placement for a given LLM training job; (v) optimizes the workload distribution between different parameter servers such that inter-machine network traffic is reduced; and (vi) efficiently allocates network bandwidth and routing paths for inter-machine network traffic.

### CROSS-REFERENCE TO RELATED APPLICATIONS

This application claims the benefit of U.S. Provisional Patent Application Ser. No. 63/666,278 filed Jul. 1, 2024, the entire contents of which is incorporated by reference as if set forth at length herein.

### FIELD OF THE INVENTION

This application relates generally to distributed computing systems and in particular distributed computing systems for large language model (LLM) training using parameter a server architecture. More particularly, it pertains to a parameter server orchestration procedure for accelerating the training of large language models.

### BACKGROUND OF THE INVENTION

Distributed Acoustic Sensing (DAS) is a DFOS technology that uses fiber optic cables to detect acoustic vibrations. It has a wide range of applications due to its unique capabilities. Its ability to detect small vibrations over long distances in real-time makes it a valuable tool for monitoring and protecting the environment

Recently, large language models (LLMs) and generative AI, such as ChatGPT, Claude, Sora and others, have been rapidly advancing in ways that may transform our daily life. As LLM model size and the corresponding training data size increases, LLMs are oftentimes trained on several GPUs in a distributed and parallel manner. In such a training process, model parameters are required to be synchronized across different GPUs in each training iteration. The parameter synchronization process now accounts for approximately 60% of the training time of the LLMs.

### SUMMARY OF THE INVENTION

An advance in the art is made according to aspects of the present disclosure directed to a parameter server orchestration procedure for accelerating the training of large language models that advantageously improves inter-machine network traffic thereby accelerating the training speed of LLMs.

In sharp contrast to the prior art, our inventive procedure advantageously (i) minimizes the amount of inter-machine network traffic thereby accelerating the training speed of LLMs from a global perspective; (ii) optimizes the topology design for a given LLM training job so that less inter-machine traffic is produced; (iii) optimizes the number of workers used and their placement for a given LLM training job; (iv) optimizes number of parameter servers employed and their placement for a given LLM training job; (v) optimizes the workload distribution between different parameter servers such that inter-machine network traffic is reduced; and (vi) efficiently allocates network bandwidth and routing paths for inter-machine network traffic.

### BRIEF DESCRIPTION OF THE DRAWING

FIG. 1 is a flow diagram showing illustrative main procedure for parameter server architecture according to aspects of the present disclosure.

FIG. 2 is a schematic diagram showing an illustrative example of a distributed computing system for LLM training using parameter server architecture with direct communication links between machines according to aspects of the present disclosure.

FIG. 3 is a schematic diagram showing an illustrative example of a distributed computing system for LLM training using parameter server architecture with switch/router for communication between machines according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note in recent years, large language models (LLMs) and generative AI, such as ChatGPT, Claude, and Sora, have been rapidly advancing to transform our daily life. As the LLM model size and the corresponding training data size increases, LLMs are usually trained on a number of GPUs in a distributed and parallel manner. In this training process, the model parameters are required to be synchronized across different GPUs in each training iteration. Parameter server architecture has been explored in the art to achieve this goal.

In the parameter server architecture, the workers are the GPUs that run the LLMs training jobs, and the parameter servers are the CPUs that synchronize the model parameters for across different workers. The model parameters at each worker are referred to as local parameters, and the model parameters at the parameter servers are referred to as global parameters. Parameter synchronization is needed in each training iteration for updating the global parameters. The parameter synchronization process consists of three steps. First, each worker trains the local LLM and sends its updated local parameters to the parameter server. Secondly, the parameter server calculates and updates the global parameters after it receives the local updates from each worker. Thirdly, each worker pulls the updated global parameters from the parameter server and then continues to the next training iteration. Note that multiple parameter servers can be used to scale up the parameter synchronization process.

Recent research has shown that there is a critical challenge in the parameter synchronization process—the network overhead caused by data transfers in the parameter synchronization process accounts for 60% of the training time of LLMs. In this invention, we propose a novel parameter server orchestration procedure to address this challenge. The proposed procedure aims to optimally orchestrate the placement of workers and parameter servers (and their workload distribution) to minimize the network overhead between different physical machines, thus leading to accelerating the training speed of LLMs.

Most existing parameter server solutions only perform the optimization for the following two tasks, (1) placing workers on GPUs and (2) placing a parameter server on CPUs. A few existing solutions neglect to consider that a physical machine may host both CPU and GPU at the same time. None of the existing solutions consider the optimization of topology design for the LLM training job (which is related to the number of workers used and the number of parameter servers used) and the workload distribution between different parameter servers.

We have discovered that the inter-machine network traffic can be significantly affected by the number of workers and the number of parameter servers used. When there is only one parameter server, adding workers on the physical machine that hosts the parameter server will not introduce additional inter-machine network traffic. When there are multiple parameter servers, adding workers will always introduce additional inter-machine network traffic. With regards to adding parameter servers, if a physical machine already hosts workers for a LLM training job, then adding a parameter server onto this physical machine will not introduce additional inter-machine network traffic. However, adding parameter servers to physical machines that does not host any existing workers will introduce additional inter-machine network traffic. In our analysis study, we also found that different workload distribution among parameter servers will result in significant difference in the amount of inter-machine network traffic.

Taking the above findings into consideration, we describe a novel and holistic parameter server orchestration procedure. Our inventive procedure jointly determines (i) the topology design (in terms of the number of worker nodes and the number of parameter server nodes used), (ii) the placement of worker nodes and parameter server nodes, (iii) the workload distribution among different parameter servers, and (iv) the routing of inter-machine network traffic. The proposed invention aims to minimize the inter-machine network traffic, thus achieving the goal of accelerating the training speed of LLMs.

As we shall show and describe, our inventive procedure advantageously improves the amount of inter-machine network traffic, thereby accelerating the training speed of LLMs from a global perspective.

Our inventive procedure improves topology design for a given LLM training job so that less inter-machine network traffic is generated.

Our inventive procedure improves the number of workers used and their placement for a given LLM training job.

Our inventive procedure improves the number of parameter servers used and their placement for a given LLM training job.

Our inventive procedure improves workload distribution between different parameter servers so that the inter-machine network traffic can be reduced.

Finally, our inventive procedure efficiently allocates network bandwidth and routing paths for inter-machine network traffic

### System and Application

As noted, our inventive procedure and disclosure is related to the distributed computing systems, and more particularly distributed computing systems for LLM training using parameter server architecture.

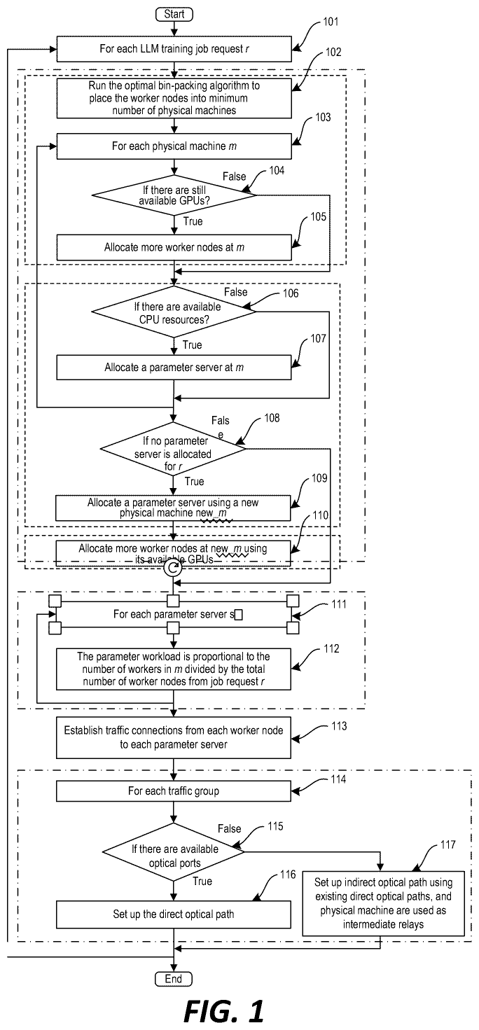

FIG. 1 is a flow diagram showing illustrative main procedure for parameter server architecture according to aspects of the present disclosure.

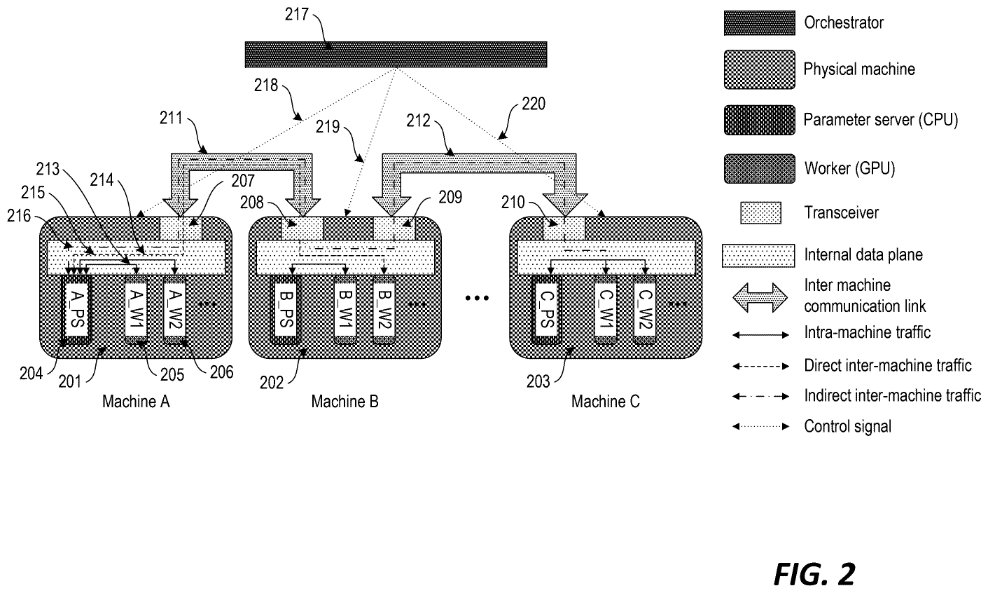

FIG. 2 is a schematic diagram showing an illustrative example of a distributed computing system for LLM training using parameter server architecture with direct communication links between machines according to aspects of the present disclosure.

In the system example illustrated in FIG. 2, there are multiple physical machines (such as Machines A, B, and C, 201 to 203) used together to share the training tasks. The number of machines can be added or reduced based on the requirement of the tasks.

Each machine contains a parameter server (usually the CPU, such as 204) and one or more workers (usually the GPUs, such as 205 and 206). Each machine may also contain transceivers that can transmit and receive data (207-210). These could be electrical transceivers or optical transceivers (bidirectional network ports). The number of transceivers (ports) can be 0, or 1 (such as Machine A and Machine C in this example), or 2 (such as Machine B), or more. There are electrical or optical communication links (such as 211 and 212 in this example) between transceiver pairs to connect these machines.

Some smaller tasks can be done using only one parameter server and the workers in the same machine, therefore there is only intra-machine traffic (such as 213 and 214 in Machine A). But when there are large training tasks as those LLMs, the number of the required workers increases, therefore the workers from other machines will be needed, which will require inter-machine communication and generate inter-machine traffic. If there are direct links available between the machine of the parameter server and the machine of the workers (such as between Machine A and Machine B in this example) and the bandwidth of these direct links is sufficient to support the required traffic capacity, these traffic can be handled by the direct inter-machine links (such as 215 between Machine A and Machine B). But if there are no direct links between the parameter server machine and the worker machine (such as between Machine A and Machine C in this example), or if the existing direct links cannot provide sufficient bandwidth, indirect inter-machine path can be established (such as 216 from Machine A to Machine C through Machine B).

The control and orchestration of these procedures (including decisions to set the physical machines, allocate LLM training tasks among the machines, assign the parameter servers and workers for the tasks, establish respective links (such as intra-machine, or direct inter-machine, or indirect inter-machine)) are decided by the orchestrator (217), and the control signals (218-220) are sent to the individual machines (201-203)

In some computing systems, switches or routers are set up among the physical machines to route the traffics. These could be optical circuit switches (if the signals are converted to optical signal by optical transceivers), or could be electrical routers (if the signals remain at electrical domain).

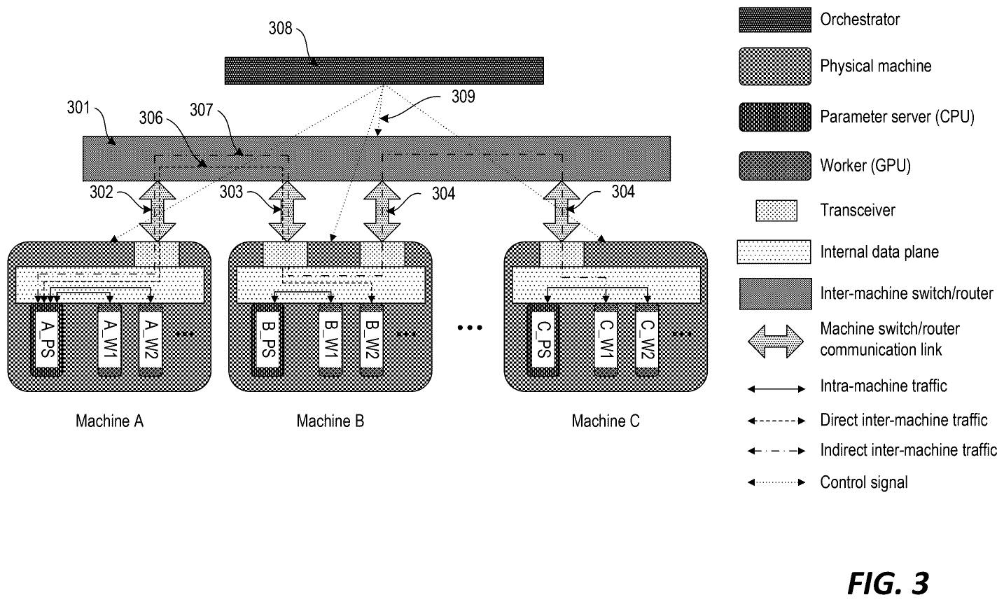

FIG. 3 shows an example of such an architecture and depicts a schematic diagram showing an illustrative example of a distributed computing system for LLM training using parameter server architecture with switch/router for communication between machines according to aspects of the present disclosure. In this system example, instead of direct communication links between two physical machines (such as 211 and 212 in FIG. 2), each machine is connected to the switch/router (301) via communication links (302-305). Each machine can have 0, 1, or multiple links. These links are for inter-machine traffics. Each link connects to a port at the switch/router.

For the inter-machine traffics, if there are sufficient ports and communication links, and if the bandwidth of these links are sufficient, direct links will be established (between the machine with parameter server and the machine with worker, through the switch/router), such as 306 in this example. If there are no sufficient bandwidth or no sufficient ports/links for dedicated traffic (such as in this case, the parameter server in Machine A needs to use workers in both Machine B and Machine C, but Machine A only has one port connecting to the switch), indirect links will be established, such as 307 in this example, in which parameter server in Machine A communicates with worker in Machine C through Machine B.

In this architecture, the orchestration is also made by the orchestrator (308). And besides controlling the physical machines (Machines A to C in this example), it also controls the switch/router (309).

### Operation Procedure

As noted, the flow diagram of our inventive procedure is shown in FIG. 1, and the detailed steps are described below. Note that for LLM training process, the workers need to be run on GPUs for training the LLM model, while the parameter server uses CPUs for synchronizing and updating the LLM model parameters across different workers. We outline the steps associated with our illustrative procedure as follows.

Step 101: This step is the starting point of a for loop. It will process each LLM computing job in the order of their arrivals. More specifically, each LLM computing job will be processed using steps 102 through 117.

Step 102: This step determines a draft plan for the number of physical machines used for accommodating the given LLM computing job request r. A bin-packing algorithm is applied here to place the workers with the objective of minimizing the number of physical machines used. In the bin packing process, the capacity of bin is corresponding to the number of GPUs on a physical machine, and the items to be packed are the workers demanded by request r.

Step 103: This step is the entering point for an inner loop. It will check each physical machine that is involved by step 102. It will determine whether or not parameter servers can be allocated on these physical machines and whether or not additional workers can be allocated on these physical machines, using steps 104 through 107.

Step 104: This step checks if a given physical machine m still has available GPU resources. If yes, it will proceed to step 105; otherwise, it will go to step 106.

Step 105: This step decides to allocate more workers using the remaining GPUs on the given physical machine m. Analysis shows that adding additional workers to the already-in-use physical machines will only introduce a limited amount of inter-machine network traffic, so more workers can be deployed on the already-in-use physical machines in this step.

Step 106: This step checks if there are available CPU resources on the given physical machine m. If yes, it goes to step 107; otherwise, it goes back to step 103 and examines the next physical machine.

Step 107: This step allocates a parameter server using the CPU resources on physical machine m.

Step 108: This step checks if at least one parameter server is allocated for the given LLM computing job request r. If none is allocated (due to the limited CPU resources in all the physical machines found by step 102), then a new physical machine that has available CPU resources is required to be used for placing a parameter server for request r, which is achieved in step 109; otherwise, it proceeds to step 111 to determine the workload distribution among different parameter servers.

Step 109: This step finds a new physical machine new_m that has available CPU resources, and then reserves sufficient CPU resources to allocate a parameter server for request r.

Step 110: This step further checks if there are still available GPUs on the newly found physical machine new_m. If yes, additional GPUs will be allocated on new_m to provide additional workers for request r.

Step 111: This step is the entering point of another inner for loop. It will check each parameter server s that is allocated for LLM computing job request r, and determine the workload distribution among different parameter servers.

Step 112: This step determines the workload for each parameter server s. The workload is proportional to the ratio of the number of workers on the physical machine that holds parameter server s over the total number of workers used by LLM computing job request r.

Step 113: This step will establish the network traffic groups from each worker to each parameter server. A network link or network traffic group is required to connect a worker to a parameter server so that the local parameters from a worker can be sent to a parameter server for synchronization.

Step 114: This step is the entering point of another inner for loop. It will process each traffic group one by one and determine the routing paths for each traffic group using steps 115 through 117.

Step 115: This step checks if there are available network ports on the two physical machines involved for the given traffic group. If yes, it proceeds to step 116 to set up direct communication paths; otherwise, it goes to step 117 to establish indirect communication paths.

Step 116: This step establishes direct communication paths between the two physical machines for the given network traffic group.

Step 117: This step establishes indirect communication paths between the two physical machines for the given network traffic group. Note that, here, indirect communication paths may traverse multiple existing direct communication paths, to connect the two physical machines. The intermediate physical machines will just serve as relays. The traffic in indirect communication paths might need to go through the optical-electrical-optical conversion, and possible traffic grooming is allowed in those intermediate relay machines

While we have presented our inventive concepts and description using specific examples, our invention is not so limited. Accordingly, the scope of our invention should be considered in view of the following claims.

1. An architecture for a computer implemented, parameter server orchestration for accelerating the training of large language models (LLMs), comprising:
an orchestrator computing machine; and
a plurality of physical computing machines, each individual one of the physical computing machines controlled by the orchestrator computing machine by control signals, each individual one of the physical computing machines controlled collectively by the orchestrator computing machine to share LLM training tasks, each individual one of the physical computing machines including a parameter server, one or more workers, and an inter-machine communication link providing communication paths between the server and the workers;
wherein the orchestrator computing machine is configured to control and orchestrate assignment of the physical computing machines, allocate LLM training tasks among the physical computing machines, assign parameter servers and workers for the LLM training tasks, and establish respective communication links among the assigned physical computing machines.

2. The architecture of claim 1 wherein the orchestration of assignment, allocation, and establishment is performed according to the number of workers and number of parameter servers.

3. The architecture of claim 2 wherein the orchestration of assignment, allocation, and establishment is performed according to the placement of workers used and number of parameter servers used.

4. The architecture of claim 3 wherein the orchestration of assignment, allocation, and establishment is performed according to workload distribution among parameter servers.

5. The architecture of claim 4 wherein the orchestration of assignment, allocation, and establishment is performed according to routing of inter-machine traffic generated by parameter synchronization in each LLM training session.
